(19) United States
(12) Patent Application Publication
(10) Pub. No.: US 2025/0241251 A1
(43) Pub. Date: Jul. 31, 2025

(54) TREE PULLER ATTACHMENT

(71) Applicant: Theodore H. CORRIHER, Terrell, NC (US)

(72) Inventor: Theodore H. CORRIHER, Terrell, NC (US)

(21) Appl. No.: 19/039,512

(22) Filed: Jan. 28, 2025

Related U.S. Application Data
(60) Provisional application No. 63/627,700, filed on Jan. 31, 2024.

(51) Int. Cl. A01G 23/06

(52) U.S. Cl. CPC A01G 23/062

(57) ABSTRACT

A tree puller attachment for an industrial or farm vehicle includes first and second jaws, which can close relative to each other to grip a trunk of a tree, shrubbery, a pole, etc. Each jaw includes a horizontally oriented, non-planar member for improved digging performance. The non-planar member is continuously curved or substantially continuously curved, by the formation of a series of short curvatures or bends along the length of the jaw. The jaws are driven by a hydraulic cylinder. Dirt riding along a surface of a member of the jaws has a clear path to pass by the hydraulic system, without contaminating or exerting pressure upon the hydraulic system. A removeable plate is attached to each of the jaws, so that serrations on facing edges of the first and second jaws, and forward-facing serrations may be replenished to a new condition when the plate is removed, rotated one hundred and eighty degrees and reattached to the jaws.

This application claims the benefit of U.S. Provisional Application No. 63/627,700, filed Jan. 31, 2024, which is herein incorporated by reference.

### BACKGROUND OF THE INVENTION

### 1. Field of the Invention

The present invention relates to a tree puller attachment for a tractor, skid steer, excavator, wheel loader or similar power-driven industrial or farm vehicle. More particularly, the present invention relates to a tree puller with curved penetrating arms to improve the digging, prying and dislodging actions needed to remove a root system associated with a tree to be pulled. Also, the present invention relates to a tree puller with an improved placement of the hydraulic actuating mechanism, and relocatable serrated plates to extend the tearing and cutting performance between service intervals.

### 2. Description of the Related Art

Traditional tree, brush and pole pullers can be seen in U.S. Pat. Nos. 3,116,048; 5,526,637; 8,544,946; 9,185,855; 9,267,307; 9,288,949 and 9,781,885, each of which is incorporated herein by reference.

Prior art FIG. 1 is an exploded perspective view from FIG. 1 in U.S. Pat. No. 9,781,885. U.S. Pat. No. 9,781,885 teaches a tree puller attachment 11 including first and second jaws 13 and 15 formed as flat panels. More specifically, the first jaw 13 is formed of a single, generally flat panel having a top surface 17 and a first saw tooth section 19 secured to the top surface 17 and extending away at a ninety-degree angle from the top surface 17. The second jaw 15 is formed as a single, generally flat panel having a top surface 21 and a second saw tooth section 23 secured to the top surface 21 and extending away at a ninety-degree angle from the top surface 21.

A hydraulic cylinder 25 is attached directly to rear ends 27 and 29 of the first and second flat panels of the first and second jaws 13 and 15. FIG. 1 shows the first and second jaws 13 and 15 in an open position when the hydraulic cylinder 25 has a pushrod 31 in a retracted position. The first and second jaw 13 and 15 would be in a closed position when the pushrod 31 of the hydraulic cylinder 25 is in an extended position.

Serrations 33 are formed on the facing edges 35 and 37 of the first and second flat panels of the first and second jaws 13 and 15. First and second forward tips 39 and 41 of the first and second jaws 13 and 15 have first and second replaceable, excavator-style digging teeth 43 and 45. Details concerning the other features of the tree puller 11 shown in prior art FIG. 1 may be found in the other figures and the text of U.S. Pat. No. 9,781,885.

As shown in prior art FIG. 2, U.S. Pat. No. 9,288,949 teaches a tree puller attachment 51 including first and second jaws 53 and 55. The first jaw 53 includes parallel flat panels 57 and 59 with an intervening first spacer panel 61. The second jaw 55 includes parallel flat panels 63 and 65 with an intervening second spacer panel 67. Serrations 64 are formed on the facing edges of the flat panels 57, 59, 63 and 65 of the first and second jaws 53 and 55. A fluid receiving portion 68 of a hydraulic cylinder 69 is directly attached to rear extension ends 71 and 73 of the parallel flat panels 57 and 59 of the first jaw 53.

As best seen in prior art FIG. 3, a pushrod 70 of the hydraulic cylinder 69 is directly attached to rear extension ends 75 and 77 of the parallel flat panels 63 and 65 of the second jaw 55. FIG. 3 also shows the first and second jaws 53 and 55 in a closed position. Note how the pushrod 70 of the hydraulic cylinder 69 is in the extended and exposed position relative to the fluid receiving portion 68 of the hydraulic cylinder 69 when the first and second jaws 53 and 55 are in the closed position. Details concerning the other features of the tree puller attachment 51 shown in prior art FIGS. 2 and 3 may be found in the other figures and the text of U.S. Pat. No. 9,288,949.

### SUMMARY OF THE INVENTION

The Applicant has appreciated drawbacks in the tree puller attachments of the prior art.

The first and second jaws are each primarily formed by a flat planar sheet of metal, or two flat planar sheets of metal with an intervening spacer panel. In the case of U.S. Pat. No. 9,781,885, the first jaw 13 is primarily formed by a flat planar sheet of metal with a flat top surface 17. Likewise, the second jaw 15 is primarily formed by a flat planar sheet of metal with a flat top surface 21. In the case of U.S. Pat. No. 9,288,949, the first jaw 53 is primarily formed by two flat planar sheets of metal 57 and 59. Likewise, the second jaw 55 is primarily formed by two flat planar sheets of metal 63 and 65.

When a tree puller is in use, the jaws are driven into the ground in front of a tree's root system by the attached industrial or farm vehicle. The jaws are then lifted by the attached industrial or farm vehicle to dig, loosen and pop out the dirt surrounding the tree's root system. The serrations on the sides and tops of the jaws assist in getting the jaw to penetrate into the dirt and can cut through or weaken any roots encountered by the jaws.

The Applicant observed that the flat planar sheets of metal have a difficult time loosening the dirt to break it free. The Applicant appreciated that a reshaping of the flat planar sheets of metal forming the jaws could enhance the ability of the jaws to loosen and pop the dirt out from around a tree's root system. To this end, the Applicant designed a reshaped horizontal member for the jaws which is non-planar. The member is continuously curved or substantially continuously curved, by the formation of a series of short curvatures or bends along the length of the jaw. The curved shape provides added leverage to pop the dirt free during the lifting process and is better suited to loosen the dirt as the penetrated jaws are lifted within the ground, e.g., breaking the ground incrementally as the jaws are lifted rather than knifing into the dirt and then trying to break free a large planar portion of dirt above the jaws.

Another drawback appreciated by the Applicant relates to potential damage to the hydraulics of the prior art tree pullers. As previously mentioned, the jaws are repeated driven into the ground to loosen and remove dirt from around a tree's root system. During the operation of the tree puller 11 in FIG. 1, dirt will continually pile onto the top surfaces 17 and 21 of the planer sheets of metal forming the first and second jaws 13 and 15. The dirt tends to become compressed, particularly along the ninety-degree channel formed along the connection between the top surfaces 17 and 21 of the first and second jaws 13 and 15 and the first and second saw tooth sections 19 and 21, respectively.

With each successive plunging of the first and second jaws 13 and 15 into the ground, the compressed dirt is pushed further along the channels toward the rear ends 27 and 29 of the planner sheets of metal forming the first and second jaws 13 and 15. Eventually, the compressed dirt will encounter the hydraulic cylinder 25 and its pushrod 31 connected to the rear ends 27 and 29 of the planner sheets forming the first and second jaws 13 and 15.

This channel of compressed dirt can exert a force against the hydraulic cylinder 25 and pushrod 31. As the first and second jaws 13 and 15 are thrust into the ground, a great force is generated by the attached industrial or farm vehicle, and the tightly compressed dirt along the channel transmits a portion of this force to the sidewall of the hydraulic cylinder 25 and the pushrod 31. If the pushrod 31 is in the exposed position, i.e., with the first and second jaws 13 and 15 partially or completely closed, the push rod may be contaminated by the dirt and may be damaged by the exerted pressure of the dirt or be deflected to cause a seal failure within the hydraulic cylinder 25.

During the operation of the tree puller 51 in FIGS. 2 and 3, a similar situation can occur in the ninety-degree channel formed between the two lower flat planar sheets 59 and 65 and the intervening first and second spacer panels 61 and 67. Dirt traveling along the channels can encounter the fluid receiving portion 68 and the pushrod 70 of the hydraulic cylinder 69 and may cause similar contamination and/or damage.

The Applicant has appreciated a repositioning of the hydraulic cylinder so as to avoid damage from compressed dirt, riding along a surface of a member of the first or second jaws. In the Applicant's invention, any dirt riding along a top surface of a member of the jaw has a clear path to pass by the hydraulic system, which greatly reduces the chances of contaminating the pushrod and exerting pressure upon the hydraulic system.

A further drawback appreciated by the Applicant relates to the serrations provided on the jaws. In the prior art tree puller 51 depicted in FIGS. 2 and 3, there are no serrations at the forward end of the jaws. Moreover, there is no easy way to replace the facing serrations 64 formed on the facing edges of the first and second jaws 53 and 55.

In the prior art tree puller 11 depicted in FIG. 1, there are also no serrations on the forward ends of the first and second jaws 13 and 15. However, the forward ends of the first and second jaws 13 and 15 have replaceable excavator-style digging teeth 43 and 45. The digging teeth 43 and 45 would be the forwardmost ends of the jaws, which penetrate into the ground. The digging teeth 43 and 45 may be removed and replaced if damaged.

The Applicant has appreciated a plate design, whereby serrations may be formed at the forwardmost, distal ends of the first and second jaws, as well as on the facing edges of the first and second jaws. Once the serrations become worn or damaged by usage, the operator may remove several threaded fasteners rotate each plate one hundred eighty degrees and reattach the plates to the forwardmost, distal ends of the first and second jaws. In so doing, the serrations on the facing edges of the first and second jaws are replenished to a new condition and, at the same time, the forward facing serrations of the first and second jaws are also replenished to a new condition.

Once the plates have been rotated and the replenished serrations have been worn, the operator may remove the plates from the first and second jaws. The plates may be taken to a machine shop, where the plate serrations may be restored by sharpening. This is an advantage over the prior art systems, wherein the serrations would need to be restored on the attachment itself. As these attachments may weigh upwards of a thousand pounds, that would mean that the operator would need to bring tools to the attachment and work on the attachment as it lays on the ground, or as it is attached to a vehicle. With the present invention, the plates may be taken to a workbench, captured by a vice, and easily re-sharpened by the operator in the comfort of a workshop.

These and other objects of the invention are addressed by a tree puller attachment for an industrial or farm vehicle, where the tree puller attachment includes first and second jaws, which can close relative to each other to grip a trunk of a tree, shrubbery, a pole, etc. Each jaw includes a horizontally oriented, non-planar member for improved digging performance. The non-planar member is continuously curved or substantially continuously curved, by the formation of a series of short curvatures or bends along the length of the jaw. The jaws are driven by a hydraulic cylinder. Dirt riding along a surface of a member of the jaws has a clear path to pass by the hydraulic system, without contaminating or exerting pressure upon the hydraulic system. A removeable plate is attached to each of the jaws, so that serrations on facing edges of the first and second jaws, and forward-facing serrations may be replenished to a new condition when the plate is removed, rotated one hundred and eighty degrees and reattached to the jaws.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a front, left side, perspective and exploded view of a tree puller, in accordance with a first embodiment of the prior art;

FIG. 2 is a front, left side, perspective view of first and second jaws of a tree puller in an open position, in accordance with a second embodiment of the prior art;

FIG. 3 is a front, left side, perspective view of the first and second jaws of FIG. 2 in a closed position;

FIG. 4 is a front, right side, perspective view of a tree puller, in accordance with the present invention;

FIG. 5 is a left side view of the tree puller of FIG. 4;

FIG. 6 is a top view of the tree puller of FIGS. 4 and 5 with first and second jaws in a partially open position;

FIG. 7 is a cross-sectional view taken along line VII-VII in FIG. 6;

FIG. 8 is a front, top perspective view of connections of the first and second jaws to a frame of the tree puller, a hydraulic system and each other;

FIG. 9 is a perspective view of a serrated wear plate;

FIG. 10 is a front, top, perspective view of the forward ends of the first and second jaws, showing serrated wear plates attached thereto;

FIG. 11 is a front, bottom, perspective view of the forward ends of the first and second jaws of FIG. 10; and

FIG. 12 is the same view as FIG. 11 after both of the serrated wear plates have been rotated one hundred eighty degrees and reattached to the forward ends of the first and second jaws.

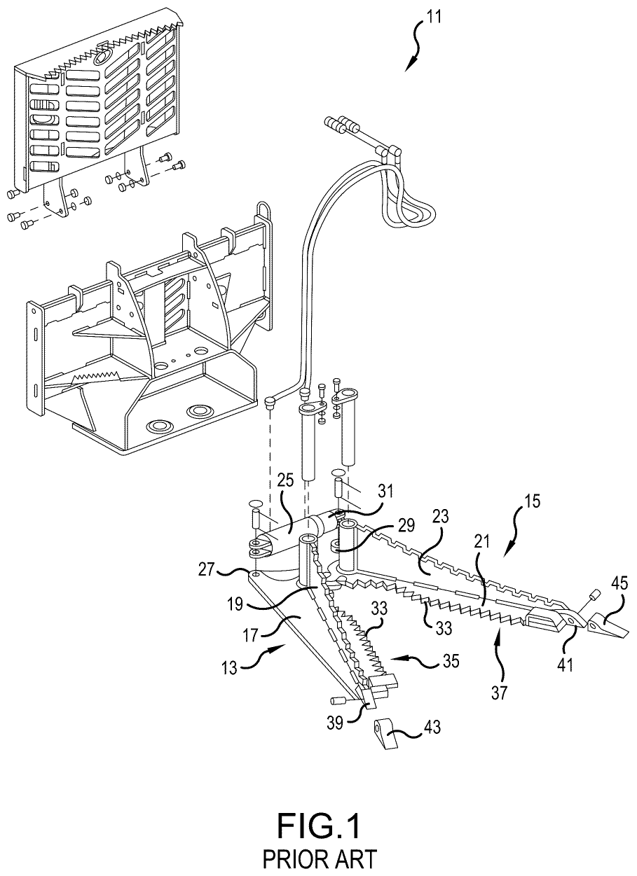

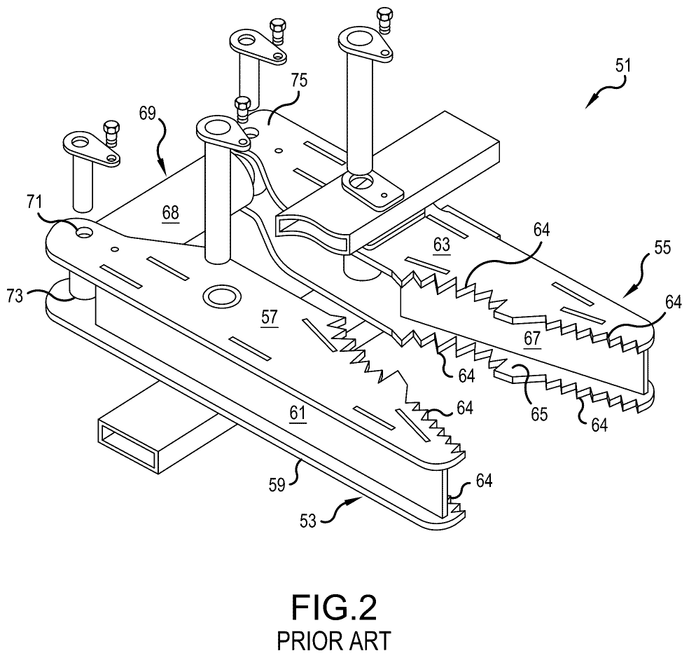

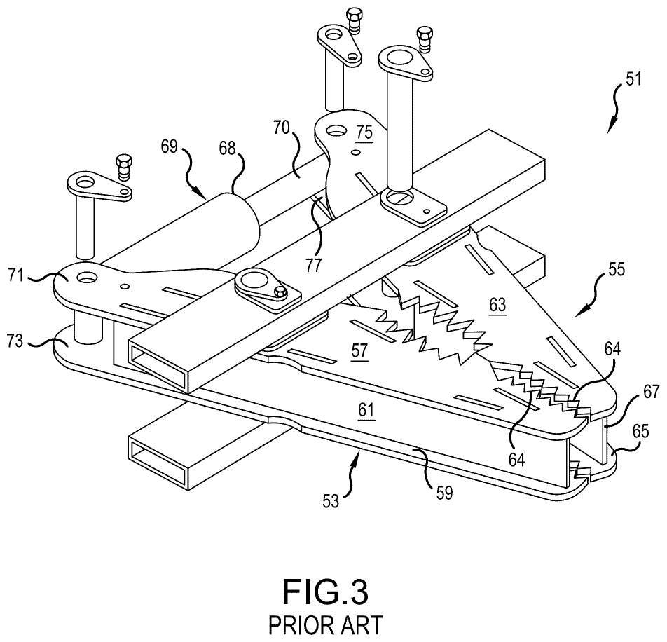

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

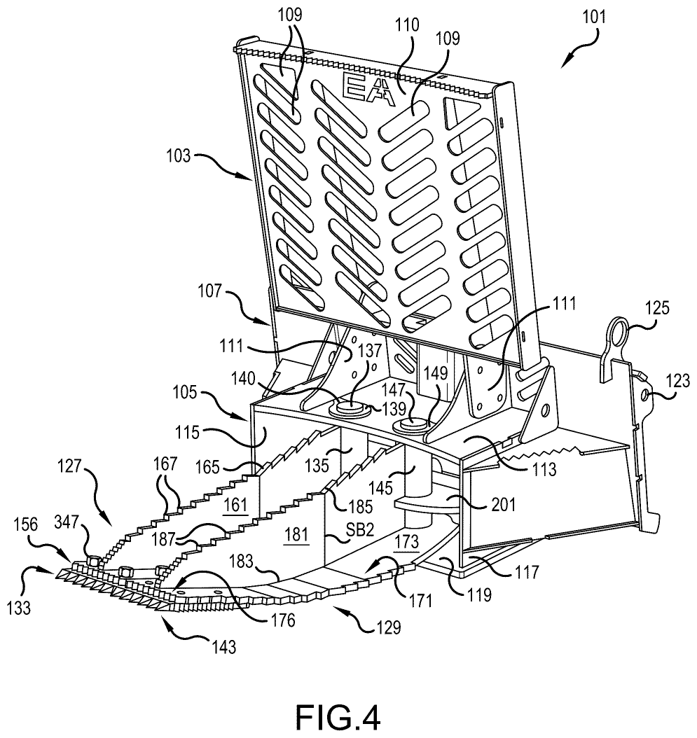

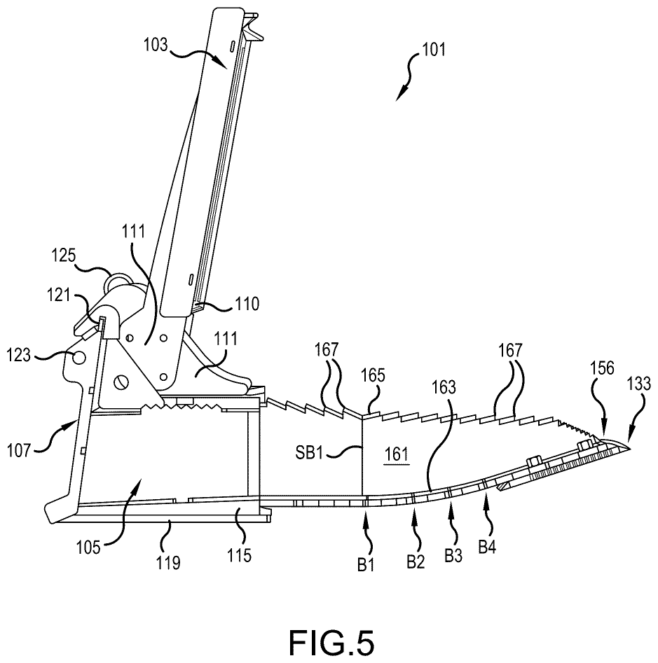

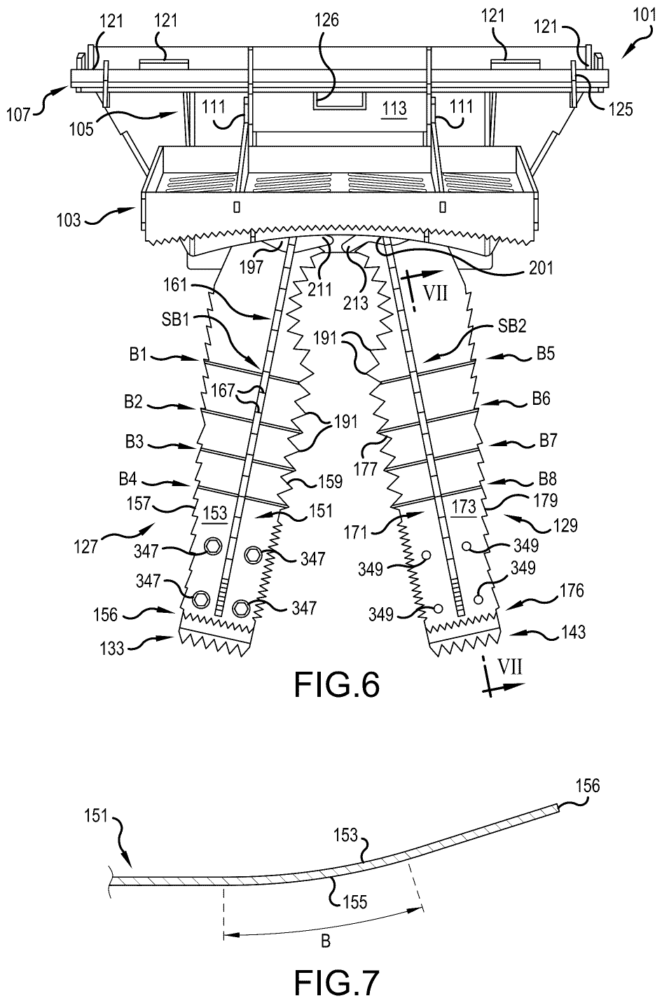

FIG. 4 is a front, right side, perspective view of a tree puller 101, in accordance with the present invention. FIG. 5 is a left side view of the tree puller 101 of FIG. 4. FIG. 6 is a top view of the tree puller of 101 FIGS. 4 and 5 with first and second jaws in a partially open position. The tree puller 101 is an attachment for a vehicle, such as a skid steer, excavator, farming tractor, wheel loader or similar power-driven industrial or farm vehicle. Although the description will detail the removal and pulling of trees from the ground, it should be understood, that the tree puller 101 can be used to dig, loosen and pull shrubbery, brush, fence posts, poles, etc. from the ground. The uses of such a tree puller attachment can be found in the prior art, referenced above.

The tree puller 101 includes a frame configured for attachment to the vehicle. In FIGS. 4-6, the frame includes the basic elements of a protective shield 103, a protective box 105 and a mounting plate 107. The protective shield 103 is provided to shield an operator and a front of the vehicle attached to the tree puller 101 from branches and flying debris. The protective shield 103 may include a plurality of spaced openings 109 formed within a forward-facing plate 110. The openings 109 are sufficient in size and number so that the operator can view a front end of the tree puller 101 during operation to control the interaction of the tree puller 101 with the ground and object, e.g., a tree, which is being removed. A lower end of the protective shield 103 is attached to a top of the protective box 105 by a plurality of brackets 111.

The protective box 105 is provided to hold a drive system, such as a hydraulic drive system, which operates the tree puller 101, as will be described in further detail hereinafter. The protective box 105 includes at least a top plate 113, first and second side plates 115 and 117 and a bottom plate 119. A front of the protective box 105 is open.

The mounting plate 107 may close a rear of the protective box 105. The mounting plate 107 includes features for attaching the tree puller 101 to a vehicle. The features may be quick-connect in nature, such as slots 121 to receive plates, or may include holes 123 to receive shafts or locking pins. The slots 121 and/or holes 123 cooperate with complemental features of a mounting system fixed to the vehicle, e.g., a three-point hitch of a farm tractor, or a quick connect feature attached to skid steer, excavator or loader bucket frame attachment of a farming tractor. The mounting plate 107 includes one or more guide hoops 125 for guiding hydraulic lines from the vehicle toward an opening 126 in the top plate 113 of the protective box 105, near a rear of the protective box 105 for ultimately connecting to the hydraulic drive system within the protective box 105.

The primary features of the tree puller 101, and the subject of the present invention, are first and second jaws 127 and 129. The first jaw 127 has a first end 131, near the mounting plate 107. The first jaw 127 also has a forward, second end 133, opposite to the first end 131, which is distanced from the mounting plate 107. A first feature of the first jaw 127 is coupled to a first portion of the frame, proximate the first end 131 of the first jaw 127. The first feature provides a pivotable attachment between the first jaw 127 and the frame. In one embodiment, the first feature of the first jaw 127 may be formed as a first cylindrical pipe 135 having a first inner diameter.

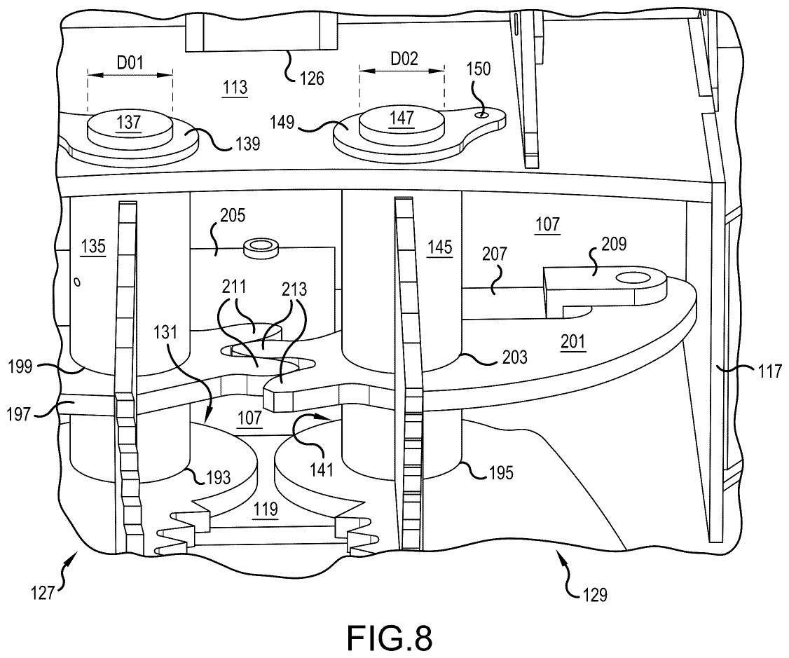

The first portion of the frame includes a first shaft 137 having a first outer diameter DO1 (See FIG. 8). The first outer diameter DO1 of the first shaft 137 is smaller than the first inner diameter of the first cylindrical pipe 135, so that the first shaft 137 fits into the first cylindrical pipe 135 for rotation therein. An end of the first shaft 137 is welded to a first mounting plate 139. The first mounting plate 139 is removably attached to the top plate 113 of the protective box 105 of the frame by at least one threaded fastener, which may pass through a through hole 140 formed in the first mounting plate 139.

The second jaw 129 has a third end 141, near the mounting plate 107. The second jaw 129 also has a forward, fourth end 143, opposite to the third end 141, which is distanced from the mounting plate 107. A second feature of the second jaw 129 is coupled to a second portion of the frame, proximate the third end 141 of the second jaw 129. The second feature provides a pivotable attachment between the second jaw 129 and the frame. In one embodiment, the second feature of the second jaw 129 may be formed as a second cylindrical pipe 145 having a first inner diameter.

The second portion of the frame includes a second shaft 147 having a second outer diameter DO2. The second outer diameter DO2 of the second shaft 147 is smaller than the second inner diameter of the second cylindrical pipe 145, so that the second shaft 147 fits into the second cylindrical pipe 145 for rotation therein. An end of the second shaft 147 is welded to a second mounting plate 149. The second mounting plate 149 is removably attached to the top plate 113 of the protective box 105 of the frame by at least one threaded fastener, which may pass through a through hole 150 formed in the second mounting plate 149. In a preferred embodiment, the first outer diameter DO1 is equal to the second outer diameter DO2, and the first and second shafts 137 and 147 with the first and second mounting plates 139 and 149 are identically formed and interchangeable.

As best seen in FIG. 6, the first jaw 127 is formed of at least a first metal plate 151 having an upper surface 153, a lower surface 155, a proximal end 131 closer to the mounting plate 107 of the frame (which is also considered the first end 131 of the first jaw 127, as best seen in FIG. 8), and a distal end 156 further from the mounting plate 107 of the frame (which is just short of the second end 133 of the first jaw 127, as will be discussed hereinafter). The first metal plate 151 also has a first side edge 157 extending from the proximal end 131 to the distal end 156, and a second side edge 159, opposite the first side edge 157, extending from the proximal end 131 to the distal end 156. The distance between the proximal end 131 and the distal end 156 may be about five to eight feet, such as about six feet.

As best seen in FIG. 5, the first metal plate 151 is characterized by a series of bends B1, B2, B3, B4 extending approximately perpendicularly between the first and second side edges 157 and 159, which series of bends B1, B2, B3, B4 are within an area located about midway between the proximal end 131 and the distal end 156 of the first metal plate 151. The series of bends B1, B2, B3, B4 may be replaced by a continuous bend. Regardless of whether a series of bends B1, B2, B3, B4 or a continuous bend is used, the first metal plate 151 is non-planar and the upper surface 153 is concave and the lower surface 155 is convex in a cross section of the first metal plate 151 taken along a line between the proximal end 131 and the distal end 156 of the first metal plate 151. A radius of curvature of the series of bends B1, B2, B3, B4 or continuous bend may be greater than three feet and less than twenty-five feet, such as greater than four feet and less than fifteen feet, most preferably about five to ten feet. In one embodiment, the radius of curvature is about five and half feet to six and a half feet.

The first jaw 127 further includes a second metal plate 161 having a third side edge 163 and a fourth side edge 165, opposite the third side edge 163. The third side edge 163 is attached to the upper surface 153 of the first metal plate 151. For example, the third side edge 163 of the second metal plate 161 has a curved shape matching the convex curvature of the upper surface 153 of the first metal plate 151 and is welded to the upper surface 153 of the first metal plate 151.

The second metal plate 161 extends away from the upper surface 153 of the first metal plate 151 at a first angle, which in a preferred embodiment is set to approximately ninety degrees. The fourth side edge 165 of said second metal plate 161 includes a plurality of serrations 167. The second metal plate 161 may optionally include a first slight bend SB1, e.g., of less than ten degrees, like less than five degrees, which is located about midway between the first and second ends 131 and 133 of the first jaw 127.

As best seen in FIGS. 4, 6 and 11, the second jaw 129 is formed of at least a third metal plate 171 having an upper surface 173, a lower surface 175, a proximal end 141 closer to the mounting plate 107 of the frame (which is also considered the third end 141 of the second jaw 129 as best seen in FIG. 8), and a distal end 176 further from the mounting plate 107 of the frame (which is just short of the fourth end 143 of the second jaw 129, as will be discussed hereinafter). The third metal plate 171 also has a fifth side edge 177 extending from the proximal end 141 to the distal end 176, and a sixth side edge 179, opposite the fifth side edge 177, extending from the proximal end 141 to the distal end 176.

As best seen in FIGS. 4 and 6, the third metal plate 171 is characterized by a series of bends B5, B6, B7, B8 extending approximately perpendicularly between the fifth and sixth side edges 177 and 179, which series of bends B5, B6, B7, B8 are within an area located about midway between the proximal end 141 and the distal end 176 of the third metal plate 171. FIG. 7 is a cross-sectional view taken along line VII-VII in FIG. 6 of the third metal plate 171, and illustrating that the series of bends B5, B6, B7, B8 may be replaced by a continuous bend B. Regardless of whether a series of bends B5, B6, B7, B8 or a continuous bend B is used, the third metal plate 171 is non-planar and the upper surface 173 is concave and the lower surface 175 is convex in a cross section of the third metal plate 171 taken along a line between the proximal end 141 and the distal end 176 of the third metal plate 171. The dimensions and radius of curvature of the third metal plate 171 may match the first metal plate 151.

The second jaw 129 further includes a fourth metal plate 181 having a seventh side edge 183 and an eighth side edge 185, opposite the seventh side edge 183. The seventh side edge 183 is attached to the upper surface 173 of the third metal plate 171. For example, the seventh side edge 183 of the fourth metal plate 181 has a curved shape matching the convex curvature of the upper surface 173 of the third metal plate 171 and is welded to the upper surface 173 of the third metal plate 171.

The fourth metal plate 181 extends away from the upper surface 173 of the third metal plate 171 at a second angle, which in a preferred embodiment is set to approximately ninety degrees. The eighth side edge 185 of said fourth metal plate 181 includes a plurality of serrations 187. The fourth metal plate 181 may optionally include a second slight bend SB2, e.g., of less than ten degrees, like less than five degrees, which is located about midway between the third and fourth ends 141 and 143 of the second jaw 129.

By the present invention, the first and third metal plates 151 and 171 are non-planar. The first and third metal plates 151 and 171 may include a continuously curved or substantially continuously curved shape, formed of a continuous bend B or series of bends B1-B8. The curved shape provides added leverage to pop the dirt free from the ground during the lifting process and is better suited to loosen the dirt as the penetrated jaws are lifted within the ground, e.g., breaking the ground incrementally as the jaws are lifted rather than knifing into the dirt and then trying to break free a large planar portion of dirt above the jaws.

FIG. 8 is a front perspective view of the pivotable connections of the first and second jaws 127 and 129 to the protective box 105 of the tree puller 101. FIG. 8 also shows a hydraulic system and interconnection between the first and second jaws 127 and 129. The pivotable attachments between the first and second jaws 127 and 129 and the frame allow at least portions of the second side edge 159 of the first metal plate 151 and portions of the fifth side edge 177 of the third metal plate 171 to directly contact, or nearly contact, each other, when the first and second jaws 127 and 129 close in a same manner as pliers. “Nearly contact” may be considered to be less than three inches from each other.

The portions of the second side edge 159 of the first metal plate 151 and portions of the fifth side edge 177 of the third metal plate 171 which directly contact, or nearly contact, each other both include serrations 191. The serrations 191 help the first and second jaws 127 and 129 to dig into the bark or outer surface of the object to be engaged by the first and second jaws 127 and 129 to pull it from the ground. FIGS. 4 and 10-12 show the first and second jaws 127 and 129 in a closed position. FIG. 6 shows the first and second jaws 127 and 129 in a partially opened position.

With reference to FIG. 8, the method of driving the first and second jaws 127 and 129 between the open and closed positions will be described. A first area 193 of the first metal plate 151, near the proximal end 131 of the first metal plate 151, is welded to a lower area of an outer surface of the first cylindrical pipe 135. A second area 195 near the proximal end 141 of the second metal plate 171 is welded to a lower area of an outer surface of the second cylindrical pipe 145. A first activation plate 197 is welded to an elevated area 199 of the outer surface of the first cylindrical pipe 135, where the elevated area 199 is spaced at least two inches above the lower area of the outer surface of the first cylindrical pipe 135, such as at least eight inches above the lower area of the outer surface of the first cylindrical pipe 135. A second activation plate 201 is welded to an elevated area 203 of the outer surface of the second cylindrical pipe 145, where the elevated area 203 is spaced at least two inches above the lower area of said outer surface of the second cylindrical pipe 145, such as at least eight inches above the lower area of the outer surface of the second cylindrical pipe 145.

The hydraulic system includes a fluid receiving cylinder 205 attached to one of the first or second activation plates 197 or 201. FIG. 8 shows the fluid receiving cylinder 205 attached to the first activation plate 197. A push rod 207 has a first end reciprocally mounted within the fluid receiving cylinder 205 and an opposite end 209 attached to the other of the first or second activation plates 197 or 201. FIG. 8 shows the opposite end 209 attached to the second activation plate 201.

The first activation plate 197 has at least two first gear teeth 211 facing toward the second activation plate 201. The second activation plate 201 has at least two second gear teeth 213 facing toward the first activation plate 197. The second gear teeth 213 are engage to the first gear teeth 211, such that a rotation of the second cylindrical pipe 145 directly causes rotation of the first cylindrical pipe 135 and vice versa. The fluid receiving cylinder 205 may include a first clevis attached to the first activation plate 197, such as by first removable pin. The opposite end 209 of the push rod 207 may include a second clevis attached to the second activation plate 201, such as by a second removable pin. To further secure attachment between the first and second cylindrical pipes 135 and 145 and the first and second jaws 127 and 129, respectively, the proximal end of the second metal plate 161 is welded to the first cylindrical pipe 135 and the first activation plate 197 and the proximal end of the fourth metal plate 181 is welded to the second cylindrical pipe 145 and the second activation plate 201.

By repositioning the hydraulic system to the first and second activation plates 197 and 201, the present invention avoids damage from compressed dirt, riding along top surfaces the first and third metal plates 151 and 171 of the first and second jaws 127 and 129, respectively. By the present invention, any dirt riding along top surfaces the first and third metal plates 151 and 171 of the first and second jaws 127 and 129 has a clear path to pass beneath the hydraulic system, which greatly reduces the chances of contaminating the pushrod 207 and exerting pressure upon the pushrod 107 and the fluid receiving cylinder 205 of the hydraulic system.

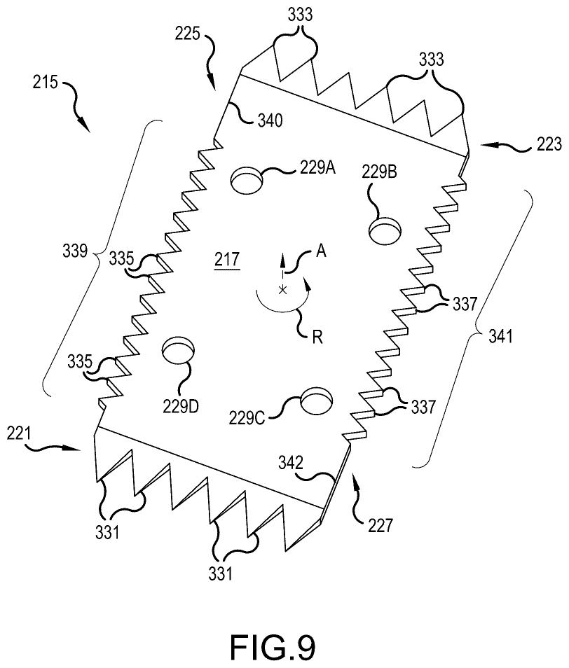

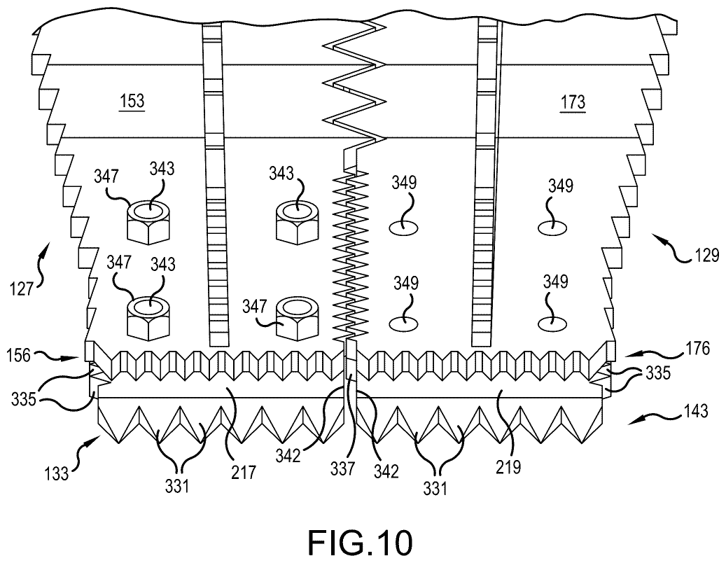

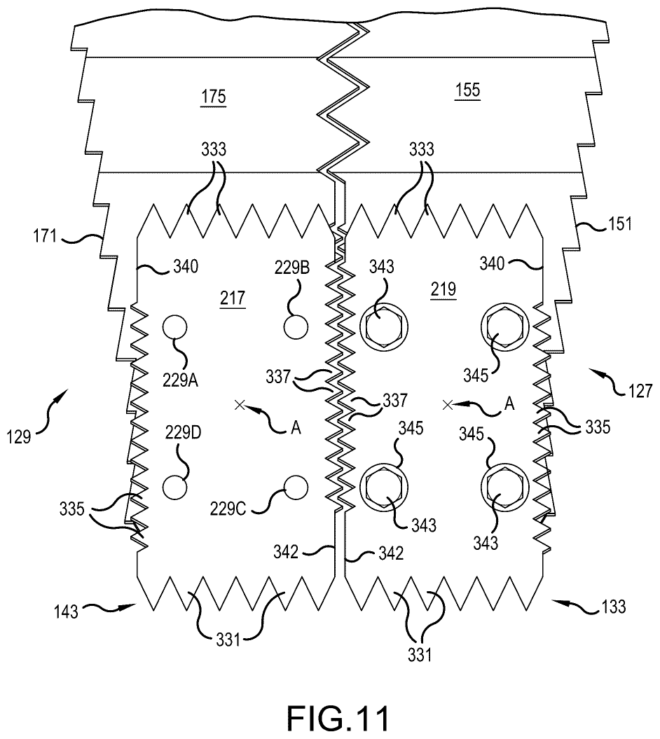

FIGS. 9-11 focus on a serrated wear plate 215 to project slightly beyond the distal ends 156 or 176 of the first and third metal plates 151 and 171. FIG. 9 is a perspective view of the serrated wear plate 215. FIG. 10 is a front, top, perspective view of the forward ends of the first and second jaws 127 and 129, showing serrated wear plates 215 attached thereto. FIG. 11 is a front, bottom, perspective view of the forward ends of the first and second jaws 127 and 129 of FIG. 10.

The serrated wear plate 215 is formed as a generally flat, rectangular plate 215 having a first surface 217, an opposite, second surface 219 (see FIG. 11), a forward edge 221, a rearward edge 223, a first side edge 225 and an opposite, second side edge 227. At least two through holes 229 are formed through the serrated wear plate 215.

FIG. 9 depicts first, second, third and fourth through holes 229A, 229B, 229C and 229D. The placement of the first, second, third and fourth through holes 229A, 229B, 229C and 229D is such that a one hundred eighty-degree rotation R of the serrated wear plate 215 about its geometric center axis A (which extends perpendicular to the plane of the serrated wear plate 215) causes the first through hole 229A to occupy the exact same spot as said third through hole 229C prior to the one hundred eight degree rotation R, and also causes said second through hole 229B to occupy the exact same spot as said fourth through hole 229D prior to the one hundred eight degree rotation R, and also causes said third through hole 229C to occupy the exact same spot as said first through hole 229A prior to the one hundred eight degree rotation R, and also causes said fourth through hole 229D to occupy the exact same spot as said second through hole 229B prior to the one hundred eight degree rotation R.

A plurality of first serrations 331 are formed along the forward edge 221. A plurality of second serrations 333 are formed along the rearward edge 223. A plurality of third serrations 335 are formed along the first side edge 225. A plurality of fourth serrations 337 are formed along the second side edge 227. The plurality of first serrations 331 may be formed completely along the forward edge 221 in a continuous sequence. The plurality of second serrations 333 may be formed completely along the rearward edge 223 in a continuous sequence.

The plurality of third serrations 335, formed along the first side edge 225, are in a first continuous sequence 339, which exists closer to the forward edge 221 as compared to the rearward edge 223. The placement of the first continuous sequence 339 leaves a first flat section 340 along the first side edge 225 adjacent to the intersection with the rearward edge 223. The plurality of fourth serrations 337, formed along the second side edge 227, are in a second continuous sequence 341, which exists closer to the rearward edge 223 as compared to the forward edge 221. The placement of the second continuous sequence 341 leaves a second flat section 342 along the second side edge 227 adjacent to the intersection with the forward edge 221.

The same serrated wear plate 215 is attached to both of the distal ends 156 or 176 of the first and third metal plates 151 and 171. However, the serrated wear plate 215 attached to the first jaw 127 is attached with its first surface 217 facing upward and in contact with an underside of the first metal plate 151. The serrated wear plate 215 attached to the second jaw 129 is attached with its second surface 219 facing upward and in contact with an underside of the second metal plate 171. The attachments may be accomplished using bolts 343, washers 345, e.g., lock washers, and nuts 347, as illustrated with regard to the serrated wear plate 215 attached to the first jaw 127. The second jaw 129 shows four through holes 349 aligned to the first, second, third and fourth through holes 229A, 229B, 229C and 229D of the serrate wear plate 215 prior to the application of the bolts 343, washers 345 and nuts 347.

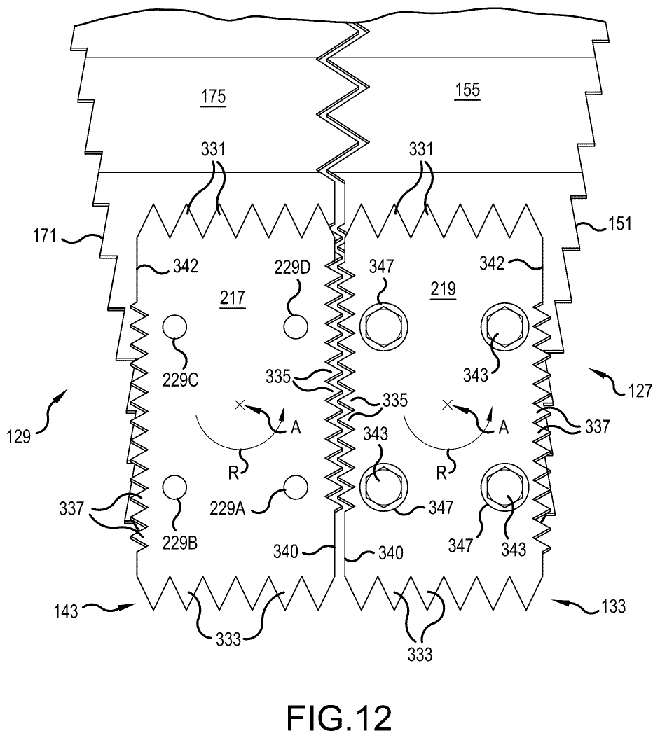

Operation of the tree puller 101, such as driving the first and second jaws 127 and 129 into the ground, and engaging the serrations on the jaws with dirt, rocks, roots and other debris will tend to wear the forwardmost serrations formed along the edges of the first and second jaws 127 and 129. Once the serrations are excessively worn, the serrated wear plates 215 may be removed from the first and second jaws 127 and 129. The serrated wear plates 215 are then rotated hundred eighty degrees in the direction R, as shown in FIG. 12, about the geometric center axis A. The serrated wear plates are then reattached to the first and second jaws 127 and 129 using the bolts 343, washers 345 and nuts 347.

FIG. 12 is the same view as FIG. 11 after both of the serrated wear plates have been rotated one hundred eighty degrees and reattached to the forward ends of the first and second jaws 127 and 129. Note that the plurality of second serrations 333 are formed along the rearward edge 223 are now located at the forward ends 133 and 143 of the first and second jaws 127 and 129. The second serrations 333 are fresh and have not previously been exposed to any digging operation. Also in FIG. 12, the plurality of third serrations 335 of the two serrated wear plates 215 are now brought into a facing relationship with each other for the purpose of gripping and sawing roots and the tree trunk. The third serrations 335 are fresh and have not previously been exposed to any digging, gripping or sawing operation, because as best seen in FIG. 11, the third serrations 335 were previously located entirely, or mostly, inside of the outer perimeter of the first and second jaws 127 and 129.

The Applicant has also appreciated that the tree puller operator may remove the serrated wear plates 215 from the first and second jaws 127 and 129. The serrated wear plates 215 may be taken to a machine shop, where and the serrations 331, 333, 335 and 337 may be restored by sharpening. This is an advantage over the prior art systems, wherein the serrations would need to be restored while on the tree puller itself. As the tree puller 101 may weigh approximately a thousand pounds, that would mean that the operator would need to bring tools to the tree puller and work on the attachment as it lays on the ground, or as it is attached to a vehicle. With the present invention, the serrated wear plates 215 may be taken to a workbench, captured by a vice, and easily re-sharpened by the operator in the comfort of a workshop.

The metal plates of the present invention may be formed of an abrasion resistant steel, like HARDOX® 450, which is approximately 3/16 of an inch thick. However, other thicknesses of a greater or lesser value are possible, such as ⅛, ¼, 5/16 or ⅜ of an inch or thicker. HARDOX® 450 is produced by SSAB, based in Oxelosund, Sweden. HARDOX® 450 has excellent structural properties and a nominal hardness of 450 HBW, which meets the standards of EN 10029, 10051 and 10131. Also, the metal plates of the present invention have been shown a single metal plate, however two or more metal plates could be laminated, e.g., stacked and welded together, to replace a single metal plate for added strength.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. An attachment for an industrial or farm vehicle, said attachment comprising:
a frame configured for attachment to the vehicle;
a first jaw having a first end, a second end, opposite said first end, and a first feature coupled to a first portion of said frame to provide a pivotable attachment between said first jaw and said frame; and
a second jaw having a third end, a fourth end, opposite said third end, and a second feature coupled to a second portion of said frame to provide a pivotable attachment between said second jaw and said frame;
wherein said first jaw is formed of at least a first metal plate having an upper surface, a lower surface, a proximal end closer to said frame, a distal end further from said frame, a first side edge extending from said proximal end to said distal end and a second side edge, opposite said first side edge, extending from said proximal end to said distal end, characterized by a series of bends or a continuous bend extending between said first and second side edges and in an area located between said proximal end and said distal end, so that said first metal plate is non-planar and said upper surface is concave and said lower surface is convex in a cross section of said first metal plate taken along a line between said proximal end and said distal end of said first metal plate.

2. The attachment according to claim 1, wherein said first jaw further includes a second metal plate having a third side edge and a fourth side edge, opposite said third side edge, wherein said third side edge is attached to said upper surface of said first metal plate, and wherein said second metal plate extends away from said upper surface of said first metal plate at a first angle.

3. The attachment according to claim 2, wherein said first angle is approximately ninety degrees.

4. The attachment according to claim 3, wherein said fourth side edge of said second metal plate includes a plurality of serrations.

5. The attachment according to claim 4, wherein said third side edge of said second metal plate has a curved shape matching the convex curvature of said upper surface of said first metal plate and is welded to said upper surface of said first metal plate.

6. The attachment according to claim 1, wherein said second jaw is formed of at least a third metal plate having an upper surface, a lower surface, a proximal end closer to said frame, a distal end further from said frame, a fifth side edge extending from said proximal end to said distal end and a sixth side edge, opposite said fifth side edge, extending from said proximal end to said distal end, characterized by a series of bends or a continuous bend extending between said fifth and sixth side edges and in an area located between said proximal end to the said distal end, so that said second metal plate is non-planar and said upper surface is concave and said lower surface is convex in a cross section of said second metal plate taken along a line between said proximal end and said distal end of said second metal plate.

7. The attachment according to claim 6, wherein the pivotable attachment between said first jaw and said frame and the pivotable attachment between said second jaw and said frame allow at least portions of said second side edge of said first metal plate and portions of said fifth side edge of said third metal plate to directly contact, or nearly contact, each other as said first and second jaws open and close as pliers.

8. The attachment according to claim 7, wherein said portions of said second side edge of said first metal plate and portions of said fifth side edge of said third metal plate which directly contact, or nearly contact, each other both include serrations.

9. The attachment according to claim 6, wherein said second jaw further includes a fourth metal plate having a seventh side edge and an eighth side edge, opposite said seventh side edge, wherein said seventh side edge is attached to said upper surface of said third metal plate, and wherein said fourth metal plate extends away from said upper surface of said third metal plate at a second angle.

10. The attachment according to claim 9, wherein said second angle is approximately ninety degrees, wherein said eighth side edge of said fourth metal plate includes a plurality of serrations, and wherein said seventh side edge of said fourth metal plate is welded to said upper surface of said third metal plate.

11. The attachment according to claim 1, wherein said first feature of said first jaw is a first cylindrical pipe having a first inner diameter, and said first portion of said frame includes a first shaft having a first outer diameter, wherein said first outer diameter is smaller than said first inner diameter, so that said first shaft fits into said first cylindrical pipe for rotation therein.

12. The attachment according to claim 11, wherein an end of said first shaft is welded to a first mounting plate, and said first mounting plate is removably attached to said frame by at least one threaded fastener.

13. An attachment for an industrial or farm vehicle, said attachment comprising:
a frame configured for attachment to the vehicle;
a first jaw having a first end, a second end, opposite said first end, and a first feature coupled to a first portion of said frame to provide a pivotable attachment between said first jaw and said frame, wherein said first feature is a first cylindrical pipe having a first inner diameter, wherein said first portion of said frame includes a first shaft having a first outer diameter, wherein said first outer diameter is smaller than said first inner diameter, so that said first shaft fits into said first cylindrical pipe for rotation therein;
a second jaw having a third end, a fourth end, opposite said third end, and a second feature coupled to a second portion of said frame to provide a pivotable attachment between said second jaw and said frame, wherein said second feature is a second cylindrical pipe having a second inner diameter, wherein said second portion of said frame includes a second shaft having a second outer diameter, wherein said second outer diameter is smaller than said second inner diameter, so that said second shaft fits into said second cylindrical pipe for rotation therein;
wherein said first jaw is formed of at least a first metal plate having an upper surface, a lower surface, a proximal end closer to said frame, a distal end further from said frame, a first side edge extending from said proximal end to said distal end and a second side edge, opposite said first side edge, extending from said proximal end to said distal end, wherein a first area near said proximal end of said first metal plate is welded to a lower area of an outer surface of said first cylindrical pipe;
wherein said second jaw is formed of at least a third metal plate having an upper surface, a lower surface, a proximal end closer to said frame, a distal end further from said frame, a fifth side edge extending from said proximal end to said distal end and a sixth side edge, opposite said fifth side edge, extending from said proximal end to said distal end, wherein a second area near said proximal end of said second metal plate is welded to a lower area of an outer surface of said second cylindrical pipe;
a first activation plate welded to an elevated area of said outer surface of said first cylindrical pipe, spaced at least two inches above said lower area of said outer surface of said first cylindrical pipe;
a second activation plate welded to an elevated area of said outer surface of said second cylindrical pipe, spaced at least two inches above said lower area of said outer surface of said second cylindrical pipe; and
a hydraulic system having a fluid receiving cylinder attached to one of said first or second activation plates and a push rod having a first end reciprocally mounted within said fluid receiving cylinder and an opposite end attached to the other of said first or second activation plates.

14. The attachment according to claim 13, wherein said first activation plate is welded to said elevated area of said outer surface of said first cylindrical pipe at least eight inches above where said first area near said proximal end of said first metal plate is welded to said lower area of said outer surface of said first cylindrical pipe, and wherein said second activation plate is welded to said elevated area of said outer surface of said second cylindrical pipe at least eight inches above where said second area near said proximal end of said second metal plate is welded to said lower area of said outer surface of said second cylindrical pipe.

15. The attachment according to claim 13, wherein said first activation plate has at least two first gear teeth facing toward said second activation plate, and wherein said second activation plate has at least two second gear teeth facing toward said first activation plate which are engage to said first gear teeth, such that a rotation of said second cylindrical pipe directly causes rotation of said first cylindrical pipe and vice versa.

16. The attachment according to claim 13, wherein said fluid receiving cylinder includes a first clevis attached to said first activation plate by a first pin, and said opposite end of said push rod includes a second clevis attached to said second activation plate by a second pin.

17. The attachment according to claim 13, wherein said first jaw further includes a second metal plate having a proximal end, a remote end, a third side edge and a fourth side edge, opposite said third side edge, wherein said third side edge is attached to said upper surface of said first metal plate, wherein said second metal plate extends away from said upper surface of said first metal plate at a first angle, and wherein said proximal end of said second metal plate is attached to said first cylindrical pipe and said first activation plate; and
wherein said second jaw further includes a fourth metal plate having a proximal end, a remote end, a seventh side edge and an eighth side edge, opposite said seventh side edge, wherein said seventh side edge is attached to said upper surface of said third metal plate, wherein said fourth metal plate extends away from said upper surface of third first metal plate at a second angle, and wherein said proximal end of said fourth metal plate is attached to said second cylindrical pipe and said second activation plate.

18. A serrated wear plate for a tree puller attachment of an industrial or farm vehicle comprising:
a first generally flat plate, having a first surface, an, opposite, second surface, a forward edge, a rearward edge, a first side edge and an opposite, second side edge;
at least two through holes formed through said first generally flat plate;
a plurality of first serrations formed along said forward edge;
a plurality of second serrations formed along said rearward edge;
a plurality of third serrations formed along said first side edge; and
a plurality of fourth serrations formed along said second side edge.

19. The serrated wear plate according to claim 18, wherein said at least two through holes includes first, second, third and fourth through holes, and wherein a one hundred eighty-degree rotation of said plate about its geometric center causes said first through hole to occupy the exact same spot as said third through hole prior to the one hundred eight degree rotation, and also causes said second through hole to occupy the exact same spot as said fourth through hole prior to the one hundred eight degree rotation, and also causes said third through hole to occupy the exact same spot as said first through hole prior to the one hundred eight degree rotation, and also causes said fourth through hole to occupy the exact same spot as said second through hole prior to the one hundred eight degree rotation.

20. The serrated wear plate according to claim 18, wherein said plurality of third serrations formed along said first side edge are in a first continuous sequence, which exists closer to said forward edge as compared to said rearward edge, and wherein said plurality of fourth serrations formed along said second side edge are in a second continuous sequence, which exists closer to said rearward edge as compared to said forward edge.
